(19) United States
(12) Patent Application Publication
(10) Pub. No.: US 2024/0054020 A1
(43) Pub. Date: Feb. 15, 2024

(54) COMPUTING RESOURCE CONFIGURATION METHODS AND APPARATUSES

(71) Applicant: Alipay (Hangzhou) Information Technology Co., Ltd., Hangzhou (CN)

(72) Inventors: Siqiao Xue, Hangzhou (CN); Xiaoming Shi, Hangzhou (CN); Cong Liao, Hangzhou (CN); Shiyi Zhu, Hangzhou (CN); Jianguo Li, Hangzhou (CN); Yangfei Zheng, Hangzhou (CN); Yun Hu, Hangzhou (CN); Lei Lei, Hangzhou (CN)

(73) Assignee: Alipay (Hangzhou) Information Technology Co., Ltd., Hangzhou (CN)

(21) Appl. No.: 18/450,036

(22) Filed: Aug. 15, 2023

(30) Foreign Application Priority Data
Aug. 15, 2022 (CN) 202210974427.6

(51) Int. Cl. G06F 9/50

(52) U.S. Cl. CPC G06F 9/5033

(57) ABSTRACT

A computer-implemented method includes determining, based on a configured computing resource share at a previous moment/time period based on an estimated traffic sequence of each application in a target period a representation vector of each application of a plurality of applications and a pre-estimated central processing unit utilization of each application. The pre-estimated central processing unit utilization of each application, the representation vector of each application, and the estimated traffic sequence of each application in the target period are input into a decision network and a current computing resource configuration policy of a first moment/time period based on an output result of the decision network. A long-term reward brought by the current computing resource configuration policy is evaluated using a predetermined policy evaluation network to adjust the output result of the decision network with an objective of maximizing the long-term reward and adjusting a current resource configuration policy.

### CROSS-REFERENCE TO RELATED APPLICATIONS

This application claims priority to Chinese Patent Application No. 202210974427.6, filed on Aug. 15, 2022, which is hereby incorporated by reference in its entirety.

### TECHNICAL FIELD

One or more embodiments of this specification relate to the field of computer technologies, and in particular, to computing resource configuration methods and apparatuses.

### BACKGROUND

Cloud native is a cloud computing application architecture that performs containerization by using an open-source stack (K8S+Docker), improves flexibility and maintainability based on a micro-service architecture, supports continuous iteration and operation and maintenance automation in an agile method by using DevOps, and implements autoscaling, dynamic scheduling, and optimized resource utilization by using a cloud platform facility. With development of a cloud native technology, capacity assurance work is characterized by different features. One most obvious feature is autoscaling, that is, automatically adjusting a computing resource based on service needs and a traffic condition. Autoscaling is a common method in cloud computing. In this method, a quantity of computing resources (usually measured based on a quantity of valid servers) in a server pool is dynamically scaled based on load in the server pool. Autoscaling is closely related to load balancing and is based on the load. In short, autoscaling allows configuration of a cloud server to be increased or decreased automatically based on computing power needs. A quantity of configured computers of the cloud server is increased when visits of the server increase and computing power is tight, until the visits decrease. The quantity of configured computers is reduced after computing power is abundant. Therefore, in a cloud native architecture, how to properly allocate a computing resource (computing power) to each application has profound impact on effective resource utilization, application service efficiency, etc.

### SUMMARY

One or more embodiments of this specification describe computing resource configuration methods and apparatuses, to resolve one or more problems mentioned in the background.

According to a first aspect, a computing resource configuration method is provided, applied to configure a computing resource for a plurality of applications in a target period. For a first moment/time period in the target period, the method includes: predicting an estimated traffic sequence of each application in the target period based on n historical traffic sequences of each of the plurality of applications in n historical periods; determining a representation vector of each application and pre-estimated CPU utilization of each application based on a configured computing resource share at a previous moment/time period based on the estimated traffic sequence of each application in the target period, where the estimated traffic sequence of each application in the target period is predicted in advance based on the n historical traffic sequences of each of the plurality of applications in the n historical periods; inputting the pre-estimated CPU utilization of each application, the representation vector of each application, and the estimated traffic sequence of each application in the target period into a decision network, and determining a current computing resource configuration policy of the first moment/time period based on an output result of the decision network; and evaluating, by using a predetermined policy evaluation network, a long-term reward brought by the current computing resource configuration policy, to adjust the current resource configuration policy with an objective of maximizing the long-term reward, where the long-term reward is determined based on a gap between the CPU utilization under the current computing resource configuration policy and predetermined target CPU utilization.

In some embodiments, in each period, each application further corresponds to a processing feature, the processing feature includes at least one of a time feature and a data update feature, and an estimated traffic sequence of a single application is predicted based on n historical traffic sequences in n historical periods and a processing feature.

In some embodiments, an estimated traffic sequence of the single application in the target period is predicted in the following manner: fusing each of the n historical traffic sequences with a corresponding processing feature in a first fusion manner, to obtain n first fusion tensors; extracting a traffic periodical feature based on the n historical traffic sequences by using the n first fusion tensors; and predicting a single estimated traffic sequence of the single application in the target period based on the traffic periodical feature and a processing feature of the target period.

In some embodiments, the first fusion manner is embedding, and the predicting an estimated traffic sequence of each application in the target period based on n historical traffic sequences of each of the plurality of applications in n historical periods includes: embedding a processing feature of the single application in the target period in the first fusion manner, to obtain a first embedding tensor; and performing processing based on a multi-head attention mechanism by using an element in the first embedding tensor as an input of a query Q and by using the traffic periodical feature as an input of a key K and a value V, to obtain the single estimated traffic sequence.

In some embodiments, the determining a representation vector of each application and pre-estimated CPU utilization of each application based on a configured computing resource share at a previous moment/time period based on the estimated traffic sequence of each application in the target period includes: correspondingly concatenating each estimated traffic sequence and a processing feature of a corresponding application based on a time dimension, to obtain each concatenation tensor; and determining the representation vector of each application and the pre-estimated CPU utilization of each application based on the configured computing resource share at the previous moment/time period based on each concatenation tensor.

In some embodiments, a representation vector of the single application is determined in the following manner: adding a perturbation that satisfies a standard Gaussian distribution to a concatenation tensor corresponding to the single application, to obtain a corresponding perturbation tensor; processing each element of the perturbation tensor in the time dimension by using a second coding network of a self-attention mechanism, and obtaining a second coding tensor of the perturbation tensor by concatenating obtained second coding results; and decoding the second code tensor, to obtain the representation vector of the single application.

In some embodiments, pre-estimated CPU utilization of the single application based on the configured computing resource share at the previous moment/time period is determined in the following manner: processing each element of a concatenation tensor corresponding to the single application in the time dimension by using a first coding network of a self-attention mechanism, to obtain each first coding result; determining, by using a third coding network of a cross-attention mechanism, a corresponding reward as a reference tensor by using each element of the concatenation tensor as a key K, by using each first coding result as a value V, and by using an element corresponding to the first moment/time period in the concatenation tensor as an input of a query Q; and processing, by using a decoding network, the representation vector, the reference tensor, and the corresponding element used as the input of the query Q in the concatenation tensor, to obtain the pre-estimated CPU utilization of the single application.

In some embodiments, the computing resource is represented by using a virtual machine instance, and the computing resource configuration policy includes a quantity of virtual machine instances allocated to each application.

In some embodiments, an input of the decision network further includes a computing resource configuration share based on a previous decision and a processing feature of the target period, the output result of the decision network is a computing resource adjustment share of each application, and the current computing resource configuration policy is determined by adjusting a previous computing resource configuration policy based on the computing resource adjustment share of each application.

In some embodiments, the long-term reward is negatively correlated with both the gap and a computing resource adjustment share conversion cost.

In some embodiments, adjusting the current resource configuration policy with an objective of maximizing the long-term reward includes: adjusting the representation vector of each application with the objective of maximizing the long-term reward; and determining the pre-estimated CPU utilization based on the adjusted representation vector, and making, by the decision network, a decision based on the adjusted representation vector and the pre-estimated CPU utilization, to determine the current computing resource configuration policy.

In some embodiments, the method further includes: when the long-term reward meets a predetermined condition, performing resource configuration for each application at the first moment/time period in the target period based on the current computing resource configuration policy.

According to a second aspect, a computing resource configuration apparatus is provided. For a first moment/time period in the target period, the apparatus is configured to configure a computing resource for a plurality of applications in the target period. The apparatus includes: a traffic prediction unit, configured to predict an estimated traffic sequence of each application in the target period based on n historical traffic sequences of each of the plurality of applications in n historical periods; a resource utilization prediction unit, configured to determine a representation vector of each application and pre-estimated CPU utilization of each application based on a configured computing resource share at a previous moment/time period based on an estimated traffic sequence of each application in the target period; a decision making unit, configured to: input the pre-estimated CPU utilization of each application, the representation vector of each application, and the estimated traffic sequence of each application in the target period into a decision network, and determine a current computing resource configuration policy of the first moment/time period based on an output result of the decision network; and an evaluation unit, configured to evaluate, by using a predetermined policy evaluation network, a long-term reward brought by the current computing resource configuration policy, to adjust the current resource configuration policy with an objective of maximizing the long-term reward, where the long-term reward is determined based on a gap between the CPU utilization under the current computing resource configuration policy and predetermined target CPU utilization.

According to a third aspect, a computer-readable storage medium is provided. The computer-readable storage medium stores a computer program, and when the computer program is executed on a computer, the computer is enabled to perform the method according to the first aspect.

According to a fourth aspect, a computing device is provided, including a memory and a processor. The memory stores executable code, and when the processor executes the executable code, the method according to the first aspect is implemented.

According to the methods and the apparatuses provided in the embodiments of this specification, by using a reinforcement learning architecture, computing resource configuration is performed for various applications at each moment/time period in a target period by predicting a traffic time sequence. In a single moment/time period configuration process, each application is represented based on a representation vector, so that a computing resource configuration solution has a migration capability, and a corresponding relationship between traffic and CPU utilization can be applied to a new application based on the representation vector. In addition, based on a policy evaluation mechanism of reinforcement learning, a long-term reward is determined with an objective of target CPU utilization, to adjust a decision result of computing resource configuration based on a case of maximizing the long-term reward, so that the computing resource configuration solution approaches the target CPU utilization at a cost as low as possible. The technical solution of computing resource configuration can implement a large-scale online application scaling scenario, and can provide a more effective scaling mechanism for cloud computing.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating an implementation scenario of this specification;

FIG. 2 is a schematic diagram illustrating a computing resource configuration implementation architecture, according to a technical concept of this specification;

FIG. 3 is a schematic diagram illustrating a computing resource configuration procedure, according to an embodiment of this specification;

FIG. 4 is a schematic diagram illustrating an implementation architecture of a traffic prediction module in a specific example;

FIG. 5 is a schematic diagram illustrating an implementation architecture of a CPU utilization prediction module in a specific example;

FIG. 6 is a schematic diagram illustrating an implementation architecture of a decision making module in a specific example; and

FIG. 7 is a block diagram illustrating a structure of a computing resource configuration apparatus, according to an embodiment of this specification.

### DESCRIPTION OF EMBODIMENTS

The solutions provided in this specification are described below with reference to the accompanying drawings.

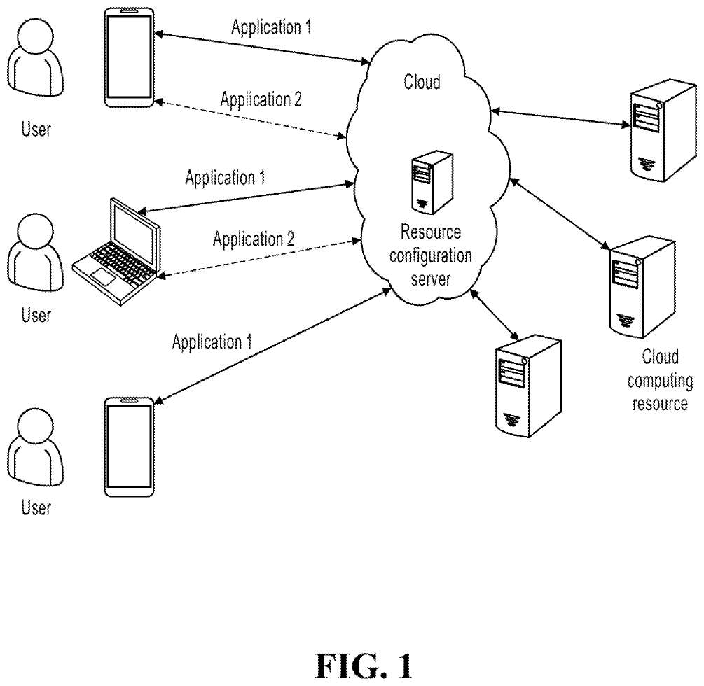

FIG. 1 is a schematic diagram illustrating an implementation scenario of this specification. In this implementation scenario, there can be at least a plurality of intelligent terminals and a cloud serving party. The intelligent terminals can be held by users, and the user interacts with the cloud serving party by using various applications installed on the intelligent terminal. The application installed on the terminal can include, for example, a shopping application, a payment application, a social platform application, a browser application, and a map application. The cloud is a serving end that can provide cloud services such as cloud computing, cloud storage, and cloud security. For example, as a cloud serving party, the cloud provides service support for various applications.

The cloud can deploy a large quantity of computing resources, for example, a maximum of 100 million virtual machines (VM) accommodated on 20 million computers, to complete the cloud service. The cloud service can support a large quantity of applications (for example, 30 million applications) to perform data processing, and can simultaneously support data processing of a plurality of applications. The cloud can schedule and configure a computing resource by using a resource configuration server, to better configure a resource for applications that simultaneously process data. Therefore, a large quantity of computing resources, for example, a quantity of computers, are configured for an application with large traffic, and a small quantity of computing resources are configured for an application with small traffic.

Traffic of an application can also be understood as load of the application, and is usually not fixed. For example, traffic of the social platform application is large during the day and small at night, traffic of a network game application is small during the day and large at night, and so on. Resource configuration can be performed in an autoscaling (scaling) manner, to properly configure a computing resource in the cloud. For example, an autoscaling mechanism is an instant dynamic scaling mode. For example, if a target value of CPU utilization of an application service is set to 75%, when the CPU utilization exceeds 75%, a policy is triggered to automatically increase a quantity of instances (for example, a quantity of virtual machines) for the service, so as to reduce CPU utilization; and when the CPU utilization is too low, the quantity of instances is reduced, to finally maintain the CPU utilization at about 75%. For another example, another autoscaling mechanism is a predictive scaling mode. A main principle of the predictive scaling mode is to analyze historical load data in a range of a plurality of days (for example, 14 days) through machine learning, and predict a load index and capacity needs in a predetermined future days (for example, 2 days). Therefore, a “scaling plan” action is introduced in the predictive scaling mode, to complete a scaling-up operation in advance when a service reaches a predicted capacity.

However, in some cases, there is a large quantity of applications of the cloud service, and there are cases such as very high stability needs of an online service feature, a large quantity of read and write applications, long cold start time, a low success rate, a delay is sensitive, a service cannot be retried, or financial-level high-sustainability service needs. In consideration that in this cases, service traffic sources and models of an online application are complex, internal traffic and external user behaviors frequently change (for example, there are many abrupt cases such as an promotion, a push message, a stock market fluctuation, a change, a plan, and service abnormality), if a traffic model is uncertain (for example, an interface method such as RPC, MSG, HTTP, and ANTQ), and continuous iteration of a service leads to a performance fluctuation (for example, function iteration, architecture upgrade, and a hybrid deployment difference of a host machine), online application resources may include bottlenecks such as a CPU, a thread pool, a hot spot, and storage.

To resolve the above-mentioned problems, this specification provides a new computing resource configuration solution. Based on traffic prediction and reinforcement learning, computing resources are properly configured when overall CPU utilization is as close to target utilization as possible, to provide a better service for each application. For example, the computing resource configuration solution can be executed by a resource configuration server in the cloud.

According to the technical concept of this specification, to adapt to online configuration of various applications, the following assumptions can be made:

(1) Load capabilities of the computing resources are balanced. For example, when 100 units of service traffic are executed by 50 virtual machines, load of each virtual machine is two units, and the two units of traffic can be unit workload of a single virtual machine.

(2) It is assumed that all applications can be classified into a limited quantity of categories, and applications belonging to a same category can be represented by using a similar vector. A similarity here can be a similarity in functions. For example, all applications are shopping applications. Alternatively, a similarity can be a similarity in service traffic distributions. For example, a shopping application and a social platform application have highest traffic in a day from 8:00 p.m. to 11:00 p.m. Similar applications can be mapped to similar representation vectors through mining by using a deep neural network.

On the basis of the above-mentioned assumptions, the computing resource configuration solution is further adjusted based on a concept of reinforcement learning in the technical concept of this specification. Reinforcement learning (RL) is one of paradigms and methodologies of machine learning, and is used to describe and resolve, based on a Markov decision process (MDP), a problem that a reward is maximized or a specific target is achieved by using a learning policy in a process in which an agent interacts with an environment. It can be learned by a person skilled in the art that, reinforcement learning is an unlabeled learning method performed based on a feedback of a sequential behavior (action). The agent observes and obtains a state s of an execution environment, and determines a to-be-taken behavior or action a for a state of a current execution environment based on a policy π. When such a behavior acts on the execution environment, the state of the execution environment is changed, and a feedback is generated. The feedback is also referred to as reward or reward score r. The agent performs learning in a trial and error method, and interacts with the environment to obtain the reward and directs the behavior action. A target is to enable the agent to obtain a maximum reward or approach a specific target as much as possible. As a reinforcement signal provided by an environment, the reward evaluates quality of a generated action, instead of notifying the agent of how to make a correct action. Because the environment provides few reinforcement signals, the agent needs to perform learning based on experience of the agent, obtain knowledge during interaction with the environment, and improve an action selection policy of the agent to adapt to the environment.

More specifically, the agent performs learning by repeatedly observing the state, determining the behavior, and receiving a feedback. A target of learning is an ideal value function or policy. The value function is a cumulative discounted reward function expected to be reached by executing the policy π.

For example, a state value function can be defined as follows:

V^{π}(s)=E_{π}[Rₜ|sₜ=s]

Rₜ represents a long-term cumulative reward obtained through execution based on a track of the policy π. The state value function represents an expectation of a cumulative reward brought by using the policy π starting from the state s.

An action-state value function can also be defined similarly:

Q^{π}(s,a)=E_{π}[Rₜ|sₜ=s,aₜ=a]

The state-action value function represents a cumulative reward brought by using the policy π after the action a is executed starting from the state s.

According to a Markov property, a relationship between the state value function and the state-action value function is as follows:

Q^{π}(s,a)= [symbol] [rₜ₊₁+γV^{π}(sₜ₊₁)]

V^{π}(s)= [symbol] _{a˜π(a|a)}[Q^{π}(s,a)]

The state value function V^{π}(s) is an expectation of the action-state value function Q^{π}(s,a) in terms of the action a, γ is an attenuation coefficient, and rₜ₊₁ represents a gain obtained by executing the action a.

According to the technical concept of this specification, the state s can be determined based on a traffic time sequence, and the action a can be an adjustment policy for a computing resource allocation policy. For example, five virtual machine instances are added for an application A. In addition, the state s can also be related to unit workload and a representation vector of an application. With reference to the above-mentioned assumptions, target CPU utilization can be used as a specific target. When CPU utilization achieved based on a computing resource allocation policy determined by the agent is consistent with the target CPU utilization, the specific target is satisfied, or a maximum reward can be obtained. Therefore, a reward provided by the environment can be determined based on a gap between the CPU utilization achieved by the computing resource allocation policy and the target CPU utilization. The action can be a quantity of computing resources to adjust. Adjustment of the action can be directed based on the gap, so that the gap is as close to 0 as possible, to obtain a maximum reward.

Therefore, with reference to reinforcement learning based on the above-mentioned assumptions, a representation vector of an application-based traffic distribution can quickly adapt to various applications, and a computing resource allocation policy is continuously adjusted under the direction of the target CPU utilization, to more accurately and effectively determine a computing resource allocation solution.

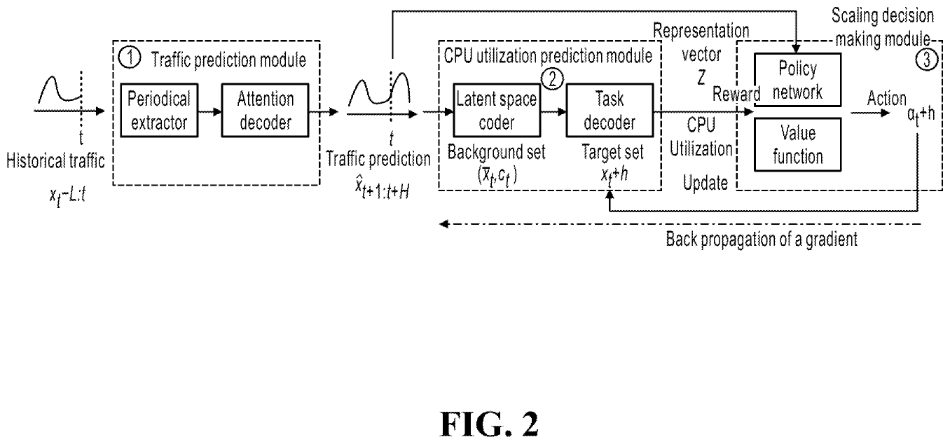

FIG. 2 shows a specific implementation architecture of a computing resource configuration method according to this specification. As shown in FIG. 2, the architecture can include three parts based on functions: a traffic prediction module, a CPU utilization prediction module \textcircled{2}, and a scaling decision making module \textcircled{3}. The following describes functions of the three modules.

The traffic prediction module can be a prediction module commonly applied to each application. The traffic prediction module can be configured to predict a traffic time sequence of a current target period based on a historical traffic time sequence of a previous historical period of each application. The traffic time sequence is a time sequence including indicator values corresponding to a service indicator, namely, service traffic in a plurality of time periods (a time unit smaller than the target period, where one time sequence period can be divided into a plurality of time periods) or at a plurality of time points. For convenience, the traffic time sequence can also be referred to as a traffic sequence in this specification. For example, service traffic data of an application at 24 exact beginnings of hours on Jul. 2, 2022 form a time sequence: 300 thousand megabytes, 100 thousand megabytes, . . . , 10 billion megabytes, 2 billion megabytes, 10 million megabytes, etc., and the time sequence is used as a traffic time sequence on Jul. 2, 2022. A future target period is, for example, Jul. 3, 2022, and the traffic time sequence in the target period can be predicted based on a plurality of historical traffic sequences (for example, L traffic time sequences respectively corresponding to L days before current time t), for example, is denoted as \hat{x}ₜ₊₁, . . . , and \hat{x}_{t+H} in FIG. 2.

Based on the above-mentioned description, CPU utilization is an important indicator of measuring computing load, and is also an important indicator of impact of computing resource allocation on computing performance. Different types of applications with same service traffic may have different impact on CPU utilization of a computer due to different service features and data features of the applications. The CPU utilization prediction module is configured to determine pre-estimated CPU utilization of each time period or time point based on a configured computing resource share of a previous time period or time point (moment) based on the traffic time sequence predicted by the traffic prediction module. The pre-estimated CPU utilization here describes CPU utilization that is of each application and that may be achieved based on corresponding traffic with a current computing resource configuration share.

In addition, based on the above-mentioned assumptions, to determine a category to which an application belongs, when the CPU utilization is predicted, a representation of a data distribution can be further considered. As shown in FIG. 2, a representation vector z determined based on the traffic time sequence predicted by the traffic prediction module is used to represent a category to which an application corresponding to a current traffic distribution belongs. That is, the CPU utilization prediction module can output two parameters: the predicted CPU utilization and a representation vector of a representation in terms of a feature of application traffic data.

Further, a scaling decision making module that makes an autoscaling decision through reinforcement learning can make a decision on a cloud computing resource allocation share based on the pre-estimated CPU utilization output by the CPU utilization prediction module and a representation vector of each application, for example, make an adjustment decision on a quantity of virtual machine instances. This is a dynamic decision making process of finding a best resource when a CPU utilization estimation is given. It can be understood that, a CPU utilization prediction value output by the CPU utilization prediction module describes the CPU utilization that is of each application and that may be achieved based on the corresponding traffic under the current computing resource configuration share. The scaling decision making module can properly increase or decrease a used computing resource share, to maintain the CPU utilization within a specific target range, and implement autoscaling. However, a relationship between a computing resource and CPU utilization is complex, and when the computing resource is adjusted, a specific cost is usually generated in the cloud (for example, an engineering cost generated when a virtual machine is switched for an application). Through reinforcement learning, an optimal quantity of virtual machines can be found while long-term costs can be reduced to a maximum extent. It is noted that, for a large-scale cloud system, model-based RL is more reliable than a model-less method, because in a reinforcement learning mode, sampling can be efficiently performed, and a potential risk caused by direct interaction between a scaling model and an online environment in a training period can be effectively avoided.

To further apply such task information to a computing resource configuration decision making process, the representation vector, the CPU utilization, and making a decision by an agent of reinforcement learning can be combined. More specifically, the representation vector, the CPU utilization, and making a decision by the agent of reinforcement learning are used as a part of an input of reinforcement learning, to participate in policy formulation and policy evaluation. It can be understood that, for the computing resource, not all computing resources need to be occupied, and costs are increased if all computing resources are occupied. Therefore, the scaling decision making module interacts with the CPU utilization prediction module, to learn how to continuously scale up a computing resource share (for example, a quantity of virtual machines), with an objective of maintaining the CPU utilization stable in a future period of time.

With reference to a reinforcement learning theory, the scaling decision making module can include a decision network and a policy evaluation network (implemented based on a value function). The decision network provides an adjustment policy of a computing resource configuration share based on the CPU utilization prediction value and the representation vector, and a decision result is, for example, a computing resource share to be adjusted for each application. A computing resource share allocated to each application can be determined (for example, a quantity of virtual machine instances configured for each application) based on the decision result. In this way, an expected gain brought by a corresponding allocation result, that is, CPU utilization corresponding to the corresponding allocation result, can be further evaluated by using the value function. In this way, a gap between overall CPU utilization corresponding to the corresponding allocation result and target CPU utilization can be evaluated by using the policy evaluation network. Based on the gap, a corresponding parameter in the CPU utilization prediction module can be adjusted, to change the representation vector z and the pre-estimated CPU utilization. Further, the decision network provides a next action, and adjusts a current configuration policy based on the action. Such a process is iterated, until the gap between the CPU utilization corresponding to the corresponding allocation result and the target CPU utilization is less than a predetermined value, and a current decision result is output.

It can be learned from the implementation architecture shown in FIG. 2 that, in the technical solution provided in this specification, a computing resource allocation policy is continuously adjusted based on reinforcement learning, to achieve a better configuration with target CPU utilization. In addition, each application is represented by using a category representation vector, and a data feature of the application is fully considered when computing resource configuration is performed, to provide a computing resource configuration solution that better conforms to a related application, and optimize a configuration process. In addition, for a new application that is not trained, a category to which the new application belongs can be quickly determined by using the representation vector z, to provide a reference for determining the computing resource configuration policy.

It is worthwhile to note that, in the implementation architecture shown in FIG. 2, the traffic prediction module can independently perform training based on the historical traffic time sequence, and the CPU utilization prediction module and the scaling decision making module can evaluate a long-term reward based on the policy evaluation network of reinforcement learning, and adjust each parameter through backward propagation of a gradient, to maximize the long-term reward, so as to complete training. In an online execution phase, a model parameter in the traffic prediction module and some parameters in the CPU utilization prediction module can be fixed. When the long-term reward does not meet a predetermined condition (for example, a trend of convergence), parameters used when the representation vector z is determined can be adjusted, for example, new random data are introduced, to change a representation of an application, and perform better resource configuration.

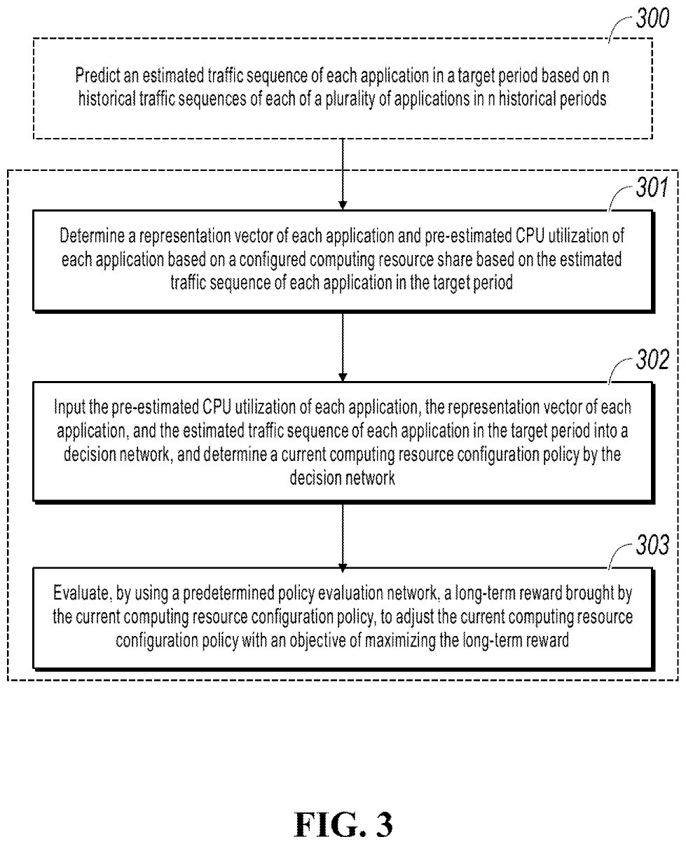

The following describes the technical concept of this specification in detail with reference to a computing resource configuration procedure in an embodiment shown in FIG. 3. The computing resource configuration procedure shown in FIG. 3 can be used to configure a computing resource for a plurality of applications in a future target period. An execution body of the computing resource configuration procedure can be a computer, a device, and a server that have a specific computing capability, for example, the resource configuration server shown in FIG. 1. It can be understood that, resource configuration processes of the applications can be performed simultaneously. In a computing resource configuration process, a resource configuration solution of a current moment/time period may depend on a resource configuration solution of a previous moment/time period. Therefore, corresponding resource configuration solutions can be sequentially determined for each moment/time period in a target period. In FIG. 3, a resource configuration decision making process of any moment/time period (referred to as a first moment/time period below) in the target period is used as an example for description. As shown in FIG. 3, the computing resource configuration procedure can include the following steps: Step 301: Determine a representation vector of each application and pre-estimated CPU utilization of each application based on a configured computing resource share at a previous moment/time period based on an estimated traffic sequence of each application in the target period, where the estimated traffic sequence of each application in the target period is predicted in advance based on n historical traffic sequences of each of the plurality of applications in n historical periods. Step 302: Input the pre-estimated CPU utilization of each application, the representation vector of each application, and the estimated traffic sequence of each application in the target period into the decision network, and determine a current computing resource configuration policy of the first moment/time period based on an output result of the decision network. Step 303: Evaluate, by using a predetermined policy evaluation network, a long-term reward brought by the current resource configuration policy, to adjust the output result of the decision network with an objective of maximizing the long-term reward, so as to adjust the current computing resource configuration policy, where the long-term reward is determined based on a gap between the CPU utilization under the current computing resource configuration policy and predetermined target CPU utilization.

First, before the resource configuration process shown in FIG. 3 is specifically described, it is worthwhile to note that, according to the technical concept shown in FIG. 2, before resource configuration is performed for the target period, traffic of each application in the target period can be first predicted. That is, there is a previous step, namely, step 300: Predict the estimated traffic sequence of each application in the target period based on the n historical traffic sequences of each of the plurality of applications in the n historical periods. This step can correspond to the traffic prediction module in FIG. 2.

The traffic sequence of each application is a time sequence including indicator values of service indicators of traffic. The traffic here can be service traffic data, for example, a service amount, a user quantity, or consumed data traffic. The service amount can also be understood as a quantity of services. For example, a purchase service implemented by a single person corresponds to a quantity 1 of service. The user quantity can be an online user quantity (a user who establishes a session with a server at a corresponding time point or in a corresponding time period). The consumed data traffic can be communication traffic consumed for processing a related service at a corresponding time point or in a corresponding time period. For example, if 128-bit traffic is consumed for a read/write operation, traffic consumed for performing 10 thousand read/write operations at the corresponding time point or in the corresponding time period is 12.8 million bits.

The historical traffic sequence can be collected based on a historical service situation. Each element of the traffic sequence corresponds to one time point or time period. The service traffic can also be periodic. For example, a shopping website has high traffic from 11:30 a.m. to 1:30 p.m. and from 8:00 p.m. to 12:00 p.m. in a day, and has low traffic in another time period during the day is low. Traffic is very low from 12:00 p.m. to 6:00 a.m. of a next day. For example, a gaming website has highest traffic from 10:00 p.m. to 4:00 a.m. of a next day, and has lowest traffic from 4:00 a.m. to 10:00 a.m. Therefore, the historical traffic sequence can be collected based on a period, and traffic data in a plurality of periods can be collected for one application. The period here is usually not less than a length of the target period of a to-be-predicted time sequence. For example, one period can be one day, three days, one week, or the like. A historical period is usually related to the target period, to properly reflect a processing feature and a data amount of a historical sequence. Usually, a length of the historical period is the same as the length of the target period.

A traffic prediction process can be implemented by using a pre-trained prediction model. Time sequences can be predicted for the plurality of applications separately or together. This is not limited here. When the time sequences are predicted for the plurality of applications together, data corresponding to all the applications can be sequentially input into a pre-trained prediction model. Based on a corresponding input format, the prediction model can automatically identify data corresponding to different applications.

In a possible design, the prediction model is a neural network whose input is a historical traffic sequence and whose output is a traffic prediction sequence of the target period, and the prediction model extracts a periodical feature of traffic data from the historical traffic sequence, to predict a sequence of the target period. The periodical feature of the traffic data can be extracted, for example, by using a convolutional neural network or a recurrent neural network. This is not limited here.

In another possible design, the traffic sequence can further correspond to a corresponding processing feature at each time point/time period. When the periodical feature is extracted from the historical traffic sequence, the processing feature can be further considered, and a known processing feature of each time point/time period in the target period is added to a traffic prediction process of the target period. Because the traffic sequence is actually traffic values arranged in a time dimension, in data processing processes of the historical period and the target period, a traffic value and a processing feature can be further aligned in the time dimension. For example, a traffic value at 9 a.m. is aligned with a processing feature at 9 a.m.

Here, the processing feature can be various features related to service processing. For example, the method can include but is not limited to a time feature, a data update feature, etc. The time feature can be used to represent a time point or time period corresponding to a single element in a time sequence of traffic. A processing feature corresponding to a single time point or time period can be described by using a feature value, for example, 9 a.m. corresponds to a feature value 9; or can be described by using a vector, for example, a vector (1, 2, 9) can be used to describe 9:00 a.m. in a work day. A data update feature is, for example, a feature that describes a service data update of a service, for example, system upgrade, data increment update, or table switching. The data increment update is used as an example. If service data (for example, knowledge graph data) of a service are updated at 2 a.m. every day based on increment data of the same day, similar to dimensions corresponding to 2 a.m. in a traffic time sequence, a corresponding dimension of a data increment update feature in a processing feature can further correspond to a predetermined feature value (for example, 1), and another dimension corresponds to another feature value (for example, 0). In an optional example, the processing feature can be described by using a multi-dimensional tensor. A two-dimensional time tensor is used as an example. The processing feature can be described by using a tensor in two time dimensions: hour of the day (time in a day, for example, 9:00 a.m. to 10:00 a.m.) and day of the week (time in one week, for example, Wednesday).

In an optional implementation, a historical traffic sequence and a processing feature of a single historical period can be fused together in a predetermined fusion manner, to form a fusion tensor, so as to predict a traffic time sequence in a future target period. Fusion here can be implemented, for example, through embedding, concatenation, or the like. Two vectors can be concatenated in terms of a dimension length; or can be concatenated by being aligned in a time dimension, for example, two vectors are arranged in parallel to form a matrix. In this way, each fusion tensor can be formed for each historical period. Here, the predetermined fusion manner can be referred to as a first fusion manner. Correspondingly, the fusion tensor obtained after fusion is referred to as a first fusion tensor.

All first fusion tensors can be combined into a tensor of a higher dimension for processing, sequentially processed in a time sequence of periods, or processed by the recurrent neural network based on periodical features of the first fusion tensors. This is not limited here. Combining all the first fusion tensors into a tensor of a higher dimension is to arrange all the first fusion tensors in sequence in terms of a dimension (for example, a time dimension), to form a tensor of a higher dimension. For example, row/column vectors are arranged in a column/row sequence to form two-dimensional tensors, and two-dimensional tensors are arranged in alignment to form a three-dimensional tensor. Sequentially processing all the first fusion tensors in a time sequence of periods or processing all the first fusion tensors by the recurrent neural network based on periodical features of the first fusion tensors each can be performed based on the recurrent neural network. The recurrent neural network is a neural network related to the past. To be specific, data that are arranged at the front in a time sequence and a processing result of the data can affect a processing result of data arranged at the back. The RNN is usually used to handle a time sequence problem. Here, performing sequential processing in a time sequence of periods is to consider data of a single period as a whole and as one piece of moment data of the RNN. Therefore, data of n historical periods forms a time sequence of n moments. In terms of time, it is more desirable to mine a traffic pattern within a period, for example, a pattern of traffic data of different moments in a day in a case in which one day is used as a period as mentioned above. In this case, first fusion tensors corresponding to all historical periods can be sequentially combined into new data of each moment based on a sequence of occurrence moments, and are sequentially input into the recurrent neural network for processing. For example, there are 10 historical periods, and each exact beginning of an hour corresponds to a moment and corresponds to a fusion feature obtained after traffic data and processing features of a single moment are fused. For an exact beginning of an hour (for example, 9 a.m.), a fusion feature of the 10 historical periods corresponds to feature data of the exact beginning of an hour including 10 elements of the exact beginning of an hour. The recurrent neural network can sequentially process fusion features of each exact beginning of an hour in 10 historical periods.

The above-mentioned processing can be performed to mine a deep data feature from a historical period, for example, at least one of impact of the processing feature in the historical traffic sequence on traffic, impact of a time feature on traffic, periodical feature of traffic, etc. In this way, a time sequence in a future target period can be predicted with reference to the processing feature of the target period, and is referred to as an estimated traffic sequence here.

The above describes a procedure of performing data processing for a single application to predict a time sequence. A prediction model can process data corresponding to each application, to obtain a corresponding estimated traffic sequence for each application. When a plurality of applications are processed together, an output result of the prediction model can be a two-dimensional tensor formed by arranging estimated traffic sequences of the plurality of applications. One dimension corresponds to each application, and one dimension corresponds to a predicted estimated traffic sequence.

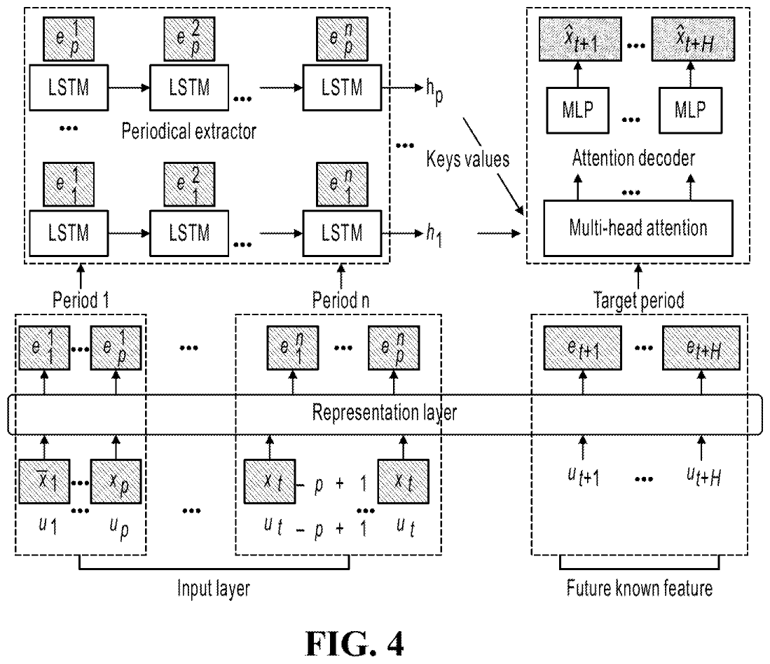

In an example, FIG. 4 shows an implementation architecture of a prediction model in a specific example. In the example shown in FIG. 4, the prediction model can include a fusion representation network (a representation layer in FIG. 4), a periodical feature extraction network (periodical extractor in FIG. 4), and a decoding prediction network (attention decoder in FIG. 4).

The fusion representation network is configured to map at least one of a traffic sequence and a processing feature in each period to a representation tensor of a predetermined quantity of dimensions. The representation tensor in a predetermined format can be referred to as a fusion tensor, to be better used for subsequent processing. For a historical period, there is both a historical traffic sequence (for example, a p-dimensional traffic sequence of x₁, . . . , and xₚ) and a processing feature (for example, a p-dimensional processing feature of u₁, . . . , and uₚ). Therefore, it can be considered that the historical traffic sequence and the processing feature are fused. In this case, the representation tensor can also be referred to as a fusion tensor.

In an optional implementation, the fusion representation network can be a linear network. The linear network has a lightweight feature. When operation needs are met, an increase in data processing complexity can be avoided. In some embodiments, the fusion representation network can be an embedded network (embedding, for example, an embedded layer of a BERT network). In this case, a fusion manner of the historical traffic sequence and the processing feature is embedding. Feature fusion can be completed through weighting, averaging, or the like. In another embodiment, the fusion representation network can be implemented by using a transformation matrix. In this case, the historical traffic sequence and the processing feature can be concatenated and then processed by the transformation matrix, to obtain a representation tensor. When the fusion manner is embedding, the representation tensor can also be referred to as an embedding tensor. For example, if the transformation matrix is represented by W, the representation tensor is represented by E, the historical traffic sequence of the single period is represented by X (for example, x₁, . . . , and xₚ), and the processing feature is represented by U (for example, u₁, . . . , and uₚ), the fusion representation network can be, for example, denoted as E=W(X+U).

In an optional implementation, the fusion representation network can be a non-linear network. For example, the fusion representation network can be implemented by using a convolutional neural network. Through processing of the convolutional neural network, at least one of the traffic sequence and the processing feature can be mapped to a representation tensor in a predetermined format. Compared with the linear network, the convolutional neural network has a more complex network structure, and can extract a higher-order feature, but has a larger network volume than the linear network, and requires more computing space in a processing process.

In another implementation, the fusion representation network can alternatively be implemented in another manner. Details are omitted here for simplicity. Usually, for the single period, one representation tensor can be obtained. In practice, data corresponding to a plurality of historical periods can alternatively be represented by a multi-dimensional tensor, so that the fusion representation network performs processing simultaneously. For example, historical traffic sequences and processing features of n historical periods can form a three-dimensional tensor in a time sequence period dimension, a time sequence length dimension, and a processing feature dimension. A two-dimensional tensor obtained through processing of a fusion representation layer is a n×p-dimensional tensor including (e₁¹, . . . , and eₚ¹), . . . , and (e₁ⁿ, . . . , eₚⁿ), or a p×n-dimensional tensor formed by transposing the n×p-dimensional tensor. N rows or n columns each correspond to n historical periods.

The periodical feature extraction network is configured to extract a period-related feature from the fusion tensor. Specifically, the periodical feature is a data change feature within a period. In FIG. 4, the periodical feature extraction network (the periodical extractor in FIG. 4) is implemented by a recurrent neural network LSTM. In other embodiments, the periodical feature extraction network can also be implemented by using another recurrent neural network. The periodical feature extraction network LSTM shown in FIG. 4 is used as an example. A single feature of a single period can be a fusion feature obtained after a processing feature and a traffic value of a corresponding time point or time period are fused. In this case, a fusion feature value of a single feature dimension in each period can form a sequence with time information. For example, it is assumed that a length of a historical traffic sequence of each historical period is p (that is, corresponding to p time points or time periods), and fusion feature values of n periods in a first dimension are sequentially e₁¹, e₁², . . . , and e₁ⁿ. By analogy, fusion feature values of n periods in the pth dimension are sequentially eₚ¹, eₚ², . . . , and eₚⁿ. These sequences can be sequentially processed by using an LSTM unit in a time sequence, or as shown in FIG. 4, the 1st dimension to the pth dimension of a fusion vector of each period are respectively and sequentially processed by using p parallel LSTM units, and finally, periodical features h₁, . . . , and hₚ are obtained in each dimension. For a single application, corresponding traffic periodical features h₁, . . . , and hₚ can form a column vector or a row vector.

The p-dimensional traffic periodical feature can be used by the decoding prediction network to predict a traffic sequence of the target period, that is, estimate the traffic sequence. When sequence prediction is performed, a processing feature (for example, “future known feature” in FIG. 4) of the target period can also be added. The processing feature can include a time feature, a data update feature, or the like. The time feature is used as an example, the time feature can be a value of each exact beginning of an hour in a 24-hour clock in a day, and corresponds to uₜ₊₁, . . . , and u_{t+H} in FIG. 4, which are a total of H items. H can be less than or equal to p. To have a consistent representation with the historical processing feature, the processing feature of the target period can also be first processed by the fusion representation network, to obtain a fusion vector (or referred to as a representation vector) of the processing feature of the target period. For example, the fusion vector is denoted as eₜ₊₁, . . . , and e_{t+H}. Then, an estimated traffic sequence of a traffic indicator in the target period can be generated based on traffic periodical features h₁, . . . , and hₚ determined by the decoding prediction network based on the historical traffic sequence in the historical period and representation vectors eₜ₊₁, . . . , and e_{t+H} corresponding to the processing feature of the target period.

The decoding prediction network can be implemented by using at least one of the convolutional neural network, a fully connected neural network, an attention network, etc. In the example shown in FIG. 4, the decoding prediction network can be implemented by using a multi-head attention network and a multi-layer perceptron (MLP). A multi-head attention mechanism can map Q, K, and V linearly for a plurality of times, to perform an attention operation for a plurality of times, so as to obtain a plurality of attention results for aggregation (for example, concatenation). Here, Q indicates a query MP, K indicates a key MP, and V indicates a value. Each different Q in the multi-head attention mechanism is observed from different aspects. In this case, different queries Q are used to score importance of input information from different perspectives, to search an input for required information in a parallel manner, and then perform aggregation in a predetermined manner. If the predetermined manner is concatenation, M queries can be denoted as att((K,V),Q)=att((K,V),q₁)⊕ . . . ⊕att((K,V),q_{M}).

Specifically, in the example shown in FIG. 4, the traffic periodical features h₁, . . . , and hₚ can be used as both K and V. In other words, K and V are the same. The representation vectors eₜ₊₁, . . . , and e_{t+H} corresponding to the processing feature of the target period are used as each Q for querying, to obtain a decoding result. The decoding result can be further processed by the multilayer perceptron (MLP for short, or referred to as an artificial neural network ANN), to be mapped to the traffic sequence of the target period, for example, \hat{x}ₜ₊₁, . . . , and \hat{x}_{t+H} in FIG. 4.

FIG. 4 shows an implementation architecture in which the estimated traffic sequence of each application in the target period is predicted based on the historical traffic sequences of the plurality of applications in the n historical periods. In practice, such a prediction can also be implemented by using another architecture. For example, historical traffic sequences and processing features of the n historical periods and processing features of each application in the target period are arranged together and processed by the convolutional neural network, to obtain an estimated traffic sequence. Details are omitted here for simplicity.

It is worthwhile to note that, because the network architecture shown in FIG. 4 is an independent prediction module, the network architecture can be trained separately based on historical data. For example, an actual traffic sequence generated for the target period is used as a label, an estimated traffic sequence is compared with the actual traffic sequence to obtain a model loss, and each model parameter is adjusted to reduce the model loss, until a model indicator meets a predetermined condition, for example, convergence of a loss function.

In an optional implementation, traffic in the estimated traffic sequence can be represented by using unit workload. The unit workload here can be understood as unit workload (for example, the ratio of predicted traffic to a quantity of machines) processed by a single machine when resources are evenly allocated. For example, if a cloud server processes two services by using five virtual machines, and a corresponding traffic vector is (100, 50), the unit workload can be (20, 10), that is, CPU unit workload when traffic of each service is evenly allocated to all machines.

After step 300 is completed, computing resource configuration can be sequentially performed based on each moment/time period. The computing resource configuration is performed for a single time/time period based on the procedure shown in FIG. 3.

First, in step 301, the representation vector of each application and the pre-estimated CPU utilization of each application based on the configured computing resource share at the previous moment/time period are determined based on the estimated traffic sequence of each application in the target period.

This step can correspond to the CPU utilization prediction module in FIG. 2. It can be learned from the above-mentioned concept of unit workload that, if configuration of the computing resource share remains unchanged and traffic changes, the unit workload changes, and therefore, the CPU utilization of the computing resource changes. Therefore, a relationship between workload (traffic) of an application and CPU utilization needs to be mined. This mapping relationship is heterogeneous. For example, (1) for different applications, mapping from workload to CPU utilization is different; (2) for a same application, there is different correlation between a subtype of workload and CPU utilization. In view of this, in this specification, an idea of meta-learning is used for reference, to train a general model for all tasks. The model maps workload to CPU utilization based on commonness and a difference between tasks.

In this process, it is assumed that each application can be represented by a vector, and the vector is referred to as a representation vector. That is, it is assumed that all applications can be classified into a limited quantity of categories, and belong to an application of a same category, and applications belonging to a same category can be represented by using a similar vector. This is also a significance of the representation vector. That is, the representation vector represents a task category to which a corresponding application belongs. When a task type of an application is considered, the task type can be used as a factor that affecting CPU utilization prediction. That is, the representation vector can be one of inputs used to predict the CPU utilization.

For ease of description, the following describes a task type of a single application, and CPU utilization of a single application at a moment t can be denoted as ĉₜ. ĉₜ here can correspond to unit workload of a single application on a single computing resource (for example, a single virtual machine instance). Usually, a corresponding feature can be first extracted from an estimated traffic sequence, and then the corresponding feature is mapped to CPU utilization and a representation vector, to implement heterogeneous mapping. Therefore, a process of extracting the corresponding feature from the estimated traffic sequence can also be considered as a coding process, and a process of mapping the corresponding feature to the CPU utilization and the representation vector can be considered as a decoding process.

In a representation process of a task, a concept of a neural process can be used for reference, and inferences of the neural network and a random process are combined to overcome some disadvantages of the two methods. The neural process can determine to model a distribution by using a function, estimate an uncertainty of a prediction based on a context observation, and transfer some work from training to test time to, achieve model flexibility.

In a specific processing process, it is considered that the representation vector is a description of applications of a task category, and is used to mine a feature of a data distribution, so that more similar data are allowed to be included, that is, a controllable deviation is allowed. Therefore, a coding process of the representation vector and a coding process of determining CPU utilization can be separately performed. A real feature value of the estimated traffic sequence can be used in the coding process of determining the CPU utilization, and in the coding process of the representation vector, a random perturbation can be added to the real feature value of the estimated traffic sequence, and perturbed data can be coded. In addition, mapping between traffic and CPU utilization is more expected to be performed based on determined traffic data. Therefore, the representation vector can be determined through processing by an independent neural network.

Based on the above-mentioned principles and concepts, a first coding network can process the estimated traffic sequence obtained in step 300, to determine a first coding result of the estimated traffic sequence; in addition, a second coding network can process the estimated traffic sequence, to determine a second coding result of the estimated traffic sequence. The first coding result represents a mapping relationship between traffic and CPU utilization, and the second coding result describes a task category corresponding to each application. Then, the decoding network decodes and fuses the first coding result and the second coding result, to predict CPU utilization corresponding to each application. In a specific implementation, the first coding network and the second coding network can be implemented by using a convolutional neural network, an attention network, or the like, and the decoding network can be implemented by using a convolutional neural network, a multilayer perceptron, or the like.

In consideration that the processing feature of the target period describes a data processing feature, in the above-mentioned coding processes, a fusion tensor of an estimated traffic sequence and a processing feature of a corresponding application can be used to replace the estimated traffic sequence for processing. The estimated traffic sequence and the processing feature of the target period can be fused through concatenation, superposition, embedding, or the like. In a manner of performing fusion through concatenation, elements in a time dimension can be concatenated correspondingly. In other words, elements corresponding to a same time point/time period are concatenated together correspondingly. In this case, the fusion tensor can be referred to as a concatenation tensor.

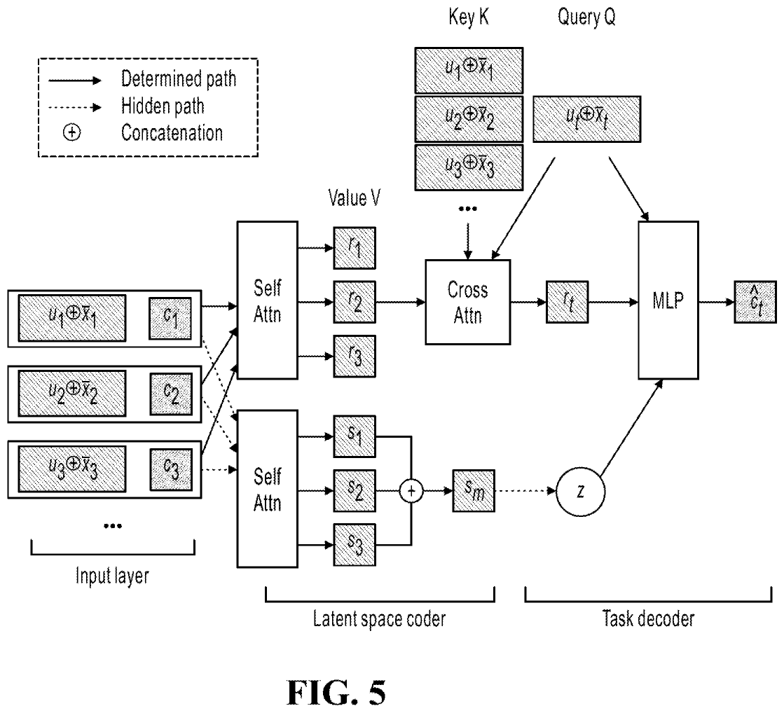

FIG. 5 shows an implementation architecture of implementing step 301 by using an example in which a first coding network and a second coding network each are an attention network and a decoding network are a multilayer perceptron. The following further describes a corresponding concept by using an example in which the implementation architecture shown in FIG. 5 processes data of a single application.

In FIG. 5, a solid arrow represents a determined path. In other words, a processing network to which the arrow points processes raw data of an arrow start item. A dotted arrow represents a hidden path, a processing network to which the arrow points processes perturbation data of an arrow start item, and ⊕ is used to indicate concatenation of tensors. As shown in FIG. 5, an estimated traffic sequence of a target period and a processing feature are concatenated, to obtain a fusion tensor described by using (c₁, c₂, c₃, . . . ).

In FIG. 5, a first coding network of a self-attention mechanism (Self Attn for short in FIG. 5) processes elements (for example, H elements, where a single element can be a value or tensor corresponding to a corresponding time point/time period) of a concatenation tensor corresponding to the signal application in a time dimension, to obtain each tensor (r₁, r₂, r₃, . . . ) with a limited quantity of dimensions, and use each tensor as each first coding result. Each first coding result is used as a query value V of a third coding network of a cross attention mechanism (Cross Attn for short in FIG. 5), a concatenation tensor corresponding to each time point/time period is used as a key K of a query, and when a concatenation tensor uₜ⊕x̅ₜ of any moment t is used as a query Q for querying, a corresponding prediction reward rₜ is provided, and is used as a reference tensor.

In addition, random noise is first added to a fusion tensor (c₁, c₂, c₃, . . . ), to introduce certain randomness, so as to mine a data feature of a traffic sequence of an application in the target period by using a random process. Random noise here can be randomly generated based on a predetermined distribution. For example, the noise data satisfy a standard Gaussian distribution, that is, satisfy a Gaussian distribution whose average value is 0 and variance is 1. The fusion tensor to which noise is added can be referred to as a perturbation tensor. For the perturbation tensor, the second coding network can code the perturbation tensor, to obtain a coding tensor (s₁, s₂, s₃, . . . ) of latent space. In FIG. 5, the second coding network is also implemented by using the self attention mechanism (Self Attention, Self Attn for short in FIG. 5). The obtained s₁, s₂, s₃, . . . are concatenated and fused, to form a tensor sₘ. Here, sₘ is processed, to obtain a tensor z that represents a task category of the application.

In FIG. 5, the first coding network and the second coding network each are a self-attention network. A self-attention model is an attention model that “dynamically” generates weights of different connections by using an attention mechanism. A self-attention is improved based on a conventional attention model, to reduce dependence on external information and more focus on an internal feature of data. The first coding network and the second coding network can jointly form a coder. That is, one coder includes two coding networks: the first coding network and the second coding network, and corresponds to two outputs that are respectively a reference tensor rₜ and a representation tensor z. For example, t represents a first moment/time period in the target period.

Further, the multilayer perceptron fuses the reference tensor rₜ, the representation tensor z, and a current query (for example, uₜ⊕x̅ₜ), to obtain a CPU utilization prediction value ĉₜ. It can be understood that, the CPU utilization prediction value ĉₜ here can be CPU utilization predicted based on a traffic change without changing a configured computing resource share, and can direct adjustment of the computing resource configuration share. For example, if traffic corresponding to a moment t−1 (a previous moment/time period corresponding to the first moment/time period) is 100, the configured computing resource share is 30, and corresponding CPU utilization is 40%, to predict CPU utilization at the moment t, the concatenation tensor uₜ⊕x̅ₜ can be determined based on predicted traffic 120 at the moment t (corresponding to the first moment/time period) and used as the query Q for querying, to obtain and provide a corresponding prediction reward rₜ as a reference tensor, and then pre-estimated CPU utilization, for example, 50%, corresponding to the configured computing resource share 30 is predicted based on the representation tensor z, the query Q, and the reference tensor rₜ. That is, the pre-estimated CPU utilization at the moment t and the CPU utilization at the moment t−1 greatly change. To maintain CPU utilization stable, a pre-estimated CPU utilization 50% can be used to make an adjustment decision on a computing resource configuration share. The reference tensor rₜ and the representation tensor z can be respectively considered as decoding results of coding results of the first coding network and the second coding network. Therefore, in FIG. 5, an implementation network that determines the reference tensor rₜ and the representation tensor z and predicts CPU utilization can be denoted as a task decoder.

The above process describes a process of pre-estimated CPU utilization ĉt of the single application at the corresponding time t (the first moment/time period). In practice, a similar principle can be used to predict the pre-estimated CPU utilization corresponding to each application at the first moment/time period in the target period.

In this way, in correspondence with the CPU utilization prediction module in FIG. 2, there are two outputs in step 301: a CPU utilization prediction value of each application and the representation tensor z. As a latent representation of a global probability, the representation tensor z can be considered as a task of embedding significant coding information of a task when context information is given. In other words, the representation tensor z can indicate a task to be completed.

In a neural network training process, the target period can correspond to known real CPU utilization. A corresponding model loss can be determined by comparing the CPU utilization prediction value and a real value, to adjust parameter values in the first coding network, the second coding network, the third coding network, the decoding network, etc. in FIG. 5 to reduce the model loss, so as to train the CPU utilization prediction module.

Then, based on step 302, the pre-estimated CPU utilization of each application, the representation vector of each application, and the estimated traffic sequence of each application in the target period are input into a decision network, and a current computing resource configuration policy of the first moment/time period is determined based on an output result of the decision network.

A computing resource configuration policy can be an allocation manner of cloud computing resources for each application. For example, the computing resource is in a form of a quantity of virtual machine instances. The resource configuration policy can describe a quantity of computers allocated to each application. The resource configuration policy can be output in a vector form, for example, (30, 80, 100, 50, . . . ). Dimensions of a vector respectively correspond to applications. For example, 30 of a first dimension indicates that 30 computers are allocated to an application 1, and so on. In a reinforcement learning architecture, the output result of the decision network usually describes an action that is performed in a current state. The current state can be described by using a computing resource share (that is, a previously adjusted resource configuration policy lₜ) currently configured for each application, a corresponding traffic value x̅ₜ in the estimated traffic sequence, the representation vector z, and the pre-estimated CPU utilization ĉₜ. If the previously adjusted computing resource configuration policy lₜ is (30, 80, 100, 50, . . . ), and an action (output result) output by the decision network can be, for example, (3, −5, 2, 5, . . . ), it indicates that three virtual machine instances are added for a first application, five virtual machine instances are reduced for a second application, . . . . Based on the action provided by the decision network, the resource configuration policy can be adjusted to (33, 75, 102, 55, . . . ).

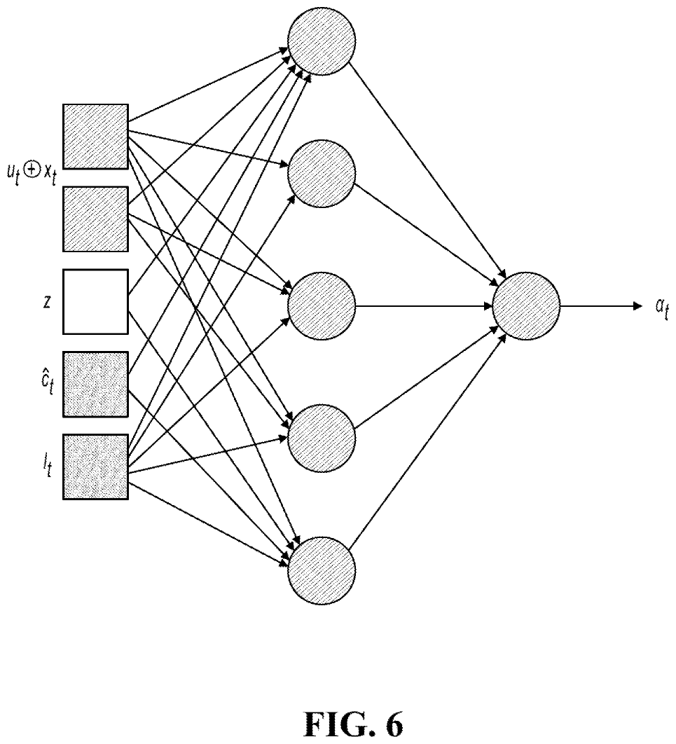

The decision result (that is, the output result) of the decision network for the action depends on the previously adjusted resource configuration policy lₜ. Therefore, in addition to the pre-estimated CPU utilization ĉₜ, the representation vector z, and the corresponding traffic value x̅ₜ of each application in the corresponding estimated traffic sequence in the target period, input data of the decision network can further include the previously adjusted computing resource configuration policy lₜ. That is, the input data of the decision network correspond to the current state s. If space in which the state s is located is considered as four-dimensional space, the state s can be described by using a four-tuple (x̅ₜ, z, ĉₜ, lₜ). In an optional embodiment, an estimated traffic value x̅t is used as an input of the decision network, and can be replaced with a concatenation tensor of a processing feature uₜ and the estimated traffic value x̅ₜ of each application that correspond to tin the target period. The decision network can be implemented in various forms of neural networks, for example, a fully connected neural network. FIG. 6 shows a decision network in a form of a fully connected neural network. The decision network can fuse various input information and obtain a corresponding computing resource configuration policy, for example, aₜ.

In the technical concept of this specification, the computing resource configuration policy can be adjusted based on a reinforcement learning theory. As shown in FIG. 6, in an adjustment process based on a reinforcement learning principle, the decision network can be a part of an agent of reinforcement learning, and a previous computing resource configuration result can also be used for reference.

Further, in step 303, a long-term reward brought by the current computing resource configuration policy is evaluated by using a predetermined policy evaluation network, to adjust the output result of the decision network to adjust the current resource configuration policy, so as to maximize the long-term reward.

For the output results of the decision network (for example, adjusting an action), a reward brought by the output result can be evaluated by using a value function. According to an objective of reinforcement learning, the computing resource share is gradually increased, and CPU utilization is maintained stable as much as possible in a certain period of time, and conversion costs of adjusting the computing resource share is minimized as much as possible. Therefore, the value function can be designed in consideration of two aspects: a gap between CPU utilization and target CPU utilization under the current computing resource configuration policy; and the conversion cost of adjusting the resource share (for example, a quantity of virtual machine instances). Therefore, in a specific example, the gap and a punishment for the cost can be weighted, so that the gap and the conversion cost of adjusting the computing resource can be reduced in a process of obtaining a maximum reward. For example, the long-term reward cumulated by using the value function is rₜ:−(c_{[t,t+1)}−c_{target})²−η(lₜ₊₁−lₜ)². Here, η is a hyperparameter of balancing weighted terms, and can be predetermined, and the target CPU utilization c_{target} can be a predetermined value, for example, 40%. In this way, the policy is applicable to a real-world setting. When corresponding CPU utilization ĉₜ′ is determined by using an adjusted computing resource allocation policy, ĉₜ′ replaces c_{[t,t+1)}, lₜ₊₁=lₜ(1+aₜ) is used, and the long-term reward rₜ can be simplified as rₜ=(ĉₜ′−c_{target})²−η(aₜlₜ)². Because the CPU utilization ĉₜ′ is a function of the state s and the action a, it can be learned that, the long-term reward rₜ is differentiable for each model parameter, that is, can be adjusted based on a gradient.

It can be learned from the above that, a policy provided by the decision network is related to a state. For example, it is denoted as a decision network aₜ=π_{ψ}(sₜ). Here, Ψ is a parameter of the decision network. A change of the state depends on a policy of a previous decision and a current state. For example, it is denoted as a dynamic model sₜ₊₁=g(sₜ,aₜ). The long-term reward rₜ in the 4-tuple is related to the state s and the action a. For example, it is denoted as a reward model r(sₜ,aₜ). Therefore, the value function is denoted as V^{π}(sₜ)= [symbol] [r(sₜ,aₜ)+γV^{π}(sₜ₊₁)]. In a decision making process, queries Q can be sequentially constructed based on H elements in the estimated traffic sequence, to cumulate long-term rewards. For a single element in the H elements, a process of reinforcement learning is a process of adjusting the parameter Ψ to maximize the long-term reward. When sₜ is described by using the four-tuple (x̅ₜ, z, ĉₜ, lₜ), z and ĉₜ are determined by using a neural network in the CPU utilization prediction module, a task representation z may have a deviation, and ĉₜ is related to the representation vector z. Therefore, a neural network related to the task representation z and a network that predicts ĉₜ based on the representation vector z can be further adjusted, to maximize the long-term reward.

To adjust the computing resource configuration policy, at least a neural network that obtains the representation vector through coding and decoding can be adjusted, to repeat step 301, step 302, and step 303. Usually, in a model training phase, CPU utilization of each application and a corresponding computing resource configuration share can be used as a decision label, and an evaluation label of the policy evaluation network is determined based on a gap between CPU utilization corresponding to a decision and target CPU utilization and a cost of adjusting the computing resource share, to determine a model loss. Then, each model parameter in the CPU utilization prediction module and the scaling decision making module is adjusted and computed with an objective of reducing the model loss. After model training is completed, the parameter Ψ of the decision network is determined, and a network parameter corresponding to the representation vector z can be adjusted with an objective of maximizing a long-term reward based on a policy evaluation module, so as to adjust the representation vector z, so that the representation vector z better represents a task category, to further adjust the output result of the decision network, and adjust the computing resource configuration policy through forward propagation.

In this way, a resource configuration policy that meets needs can be determined by repeatedly adjusting the computing resource configuration policy in a technical concept of reinforcement learning. Further, when the long-term reward meets a predetermined condition, a repeated adjustment process of reinforcement learning is stopped. The predetermined condition here is, for example, convergence of the long-term reward. For example, an average value of changes in a plurality of adjustment periods is less than a predetermined value q close to 0. In this case, the current computing resource configuration policy can be determined based on an adjustment policy output by the decision network, and the policy is applied to configuration of the computing resource configuration share of each application.

The above process describes a process of configuring a computing resource corresponding to a first moment/time period (for example, corresponding to the moment t). In practice, the moment t can be changed, to predict a computing resource configuration solution of an application at different time points/time periods in the target period.

The above process is reviewed. Based on a concept of combining traffic prediction and decision making of reinforcement learning, computing resource configuration is performed for each application by predicting a traffic time sequence. In a configuration process, each application is represented based on a representation vector, so that a computing resource configuration solution has a migration capability, and a corresponding relationship between traffic and CPU utilization can be applied to a new application based on the representation vector. In addition, based on a policy evaluation mechanism of reinforcement learning, a long-term reward is determined with an objective of target CPU utilization, to adjust a decision result of computing resource configuration based on a case of maximizing the long-term reward, so that the computing resource configuration solution approaches the target CPU utilization at a cost as low as possible. The technical solution of computing resource configuration can implement a large-scale online application scaling scenario, and can provide a more effective scaling mechanism for cloud computing.

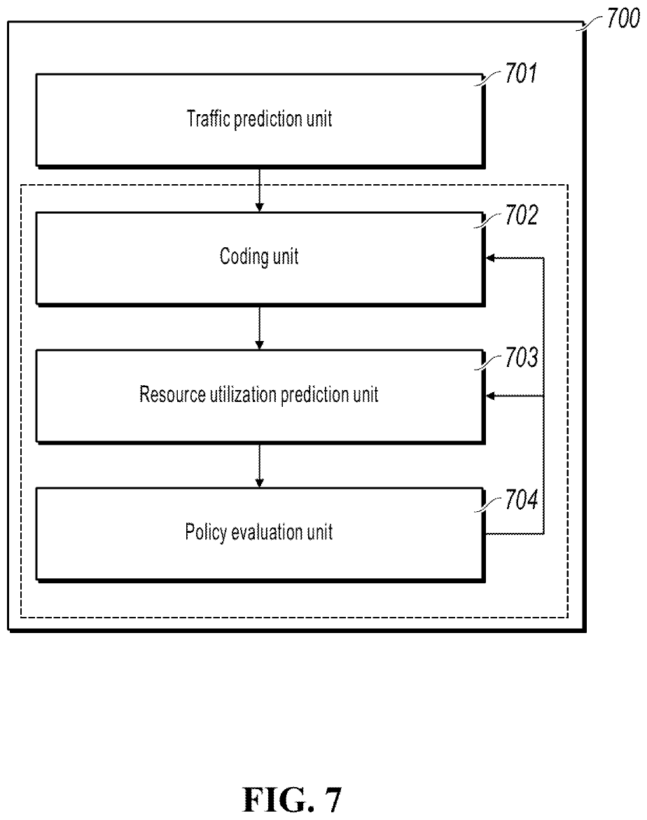

Embodiments in another aspect further provides a computing resource configuration apparatus, configured to configure a computing resource for a plurality of applications in a target period. The apparatus can be disposed on a resource configuration server in the cloud. FIG. 7 shows a computing resource configuration apparatus 700 according to an embodiment. As shown in FIG. 7, the apparatus 700 includes: a traffic prediction unit 701, configured to predict an estimated traffic sequence of each application in the target period based on n historical traffic sequences of each of the plurality of applications in n historical periods; a resource utilization prediction unit 702, configured to: for each moment/time period in the target period, determine a representation vector of each application and pre-estimated CPU utilization of each application based on a configured computing resource share at a previous moment/time period based on an estimated traffic sequence of each application in the target period; a decision making unit 703, configured to: input the pre-estimated CPU utilization of each application, the representation vector of each application, and the estimated traffic sequence of each application in the target period into a decision network, and determine a current computing resource configuration policy of a current moment/time period based on an output result of the decision network; and an evaluation unit 704, configured to evaluate, by using a predetermined policy evaluation network, a long-term reward brought by the current computing resource configuration policy, to adjust the current resource configuration policy with an objective of maximizing the long-term reward, where the long-term reward is determined based on a gap between the CPU utilization under the current computing resource configuration policy and predetermined target CPU utilization.

In a possible design, the apparatus 700 can further include a resource configuration unit (not shown), configured to: when the long-term reward meets a predetermined condition, perform resource configuration for each application at the current moment/time period in the target period based on the current computing resource configuration policy.

It is worthwhile to note that, the apparatus 700 can correspond to the method embodiment in FIG. 3. Therefore, the descriptions in the method embodiment in FIG. 3 is also applicable to the apparatus 700. Details are omitted here for simplicity.

Embodiments in another aspect further provide a computer-readable storage medium. The computer-readable storage medium stores a computer program. When the computer program is executed on a computer, the computer is enabled to perform the method described with reference to FIG. 3, or the like.

An embodiment in still another aspect further provides a computing device, including a memory and a processor. The memory stores executable code, and when executing the executable code, the processor implements the method described with reference to FIG. 3, or the like.

A person skilled in the art should be aware that in the above-mentioned one or more examples, functions described in the embodiments of this specification can be implemented by hardware, software, firmware, or any combination thereof. When being implemented by software, these functions can be stored in a computer-readable medium or transmitted as one or more instructions or code in the computer-readable medium.

The objectives, technical solutions, and beneficial effects of the technical concepts of this specification have been further described in detail in the above-mentioned specific implementations. It should be understood that the above-mentioned description is merely specific implementations of the technical concepts of this specification and do not intend to limit the protection scope of the technical concepts of this specification. Any modification, equivalent replacement, improvement, etc. made based on the technical solutions of the embodiments of this specification shall fall within the protection scope of the technical concepts of this specification.

What is claimed is:

1. A computer-implemented method for computing resource configuration, comprises:
determining, based on a configured computing resource share at a previous moment/time period based on an estimated traffic sequence of each application in a target period a representation vector of each application of a plurality of applications and a pre-estimated central processing unit utilization of each application, wherein the estimated traffic sequence of each application in the target period is predicted in advance based on n historical traffic sequences of each of the plurality of applications in n historical periods;
inputting the pre-estimated central processing unit utilization of each application, the representation vector of each application, and the estimated traffic sequence of each application in the target period into a decision network;
determining a current computing resource configuration policy of a first moment/time period based on an output result of the decision network; and
evaluating, by using a predetermined policy evaluation network, a long-term reward brought by the current computing resource configuration policy, to adjust the output result of the decision network with an objective of maximizing the long-term reward, so as to adjust a current resource configuration policy, wherein the long-term reward is determined based on a gap between central processing unit utilization under the current computing resource configuration policy and a predetermined target central processing unit utilization.

2. The computer-implemented method of claim 1, wherein in each period:
each application corresponds to a processing feature comprising at least one of a time feature and a data update feature.

3. The computer-implemented method of claim 2, wherein
an estimated traffic sequence of a single application is predicted based on n historical traffic sequences in n historical periods and a processing feature.

4. The computer-implemented method of claim 3, wherein an estimated traffic sequence of the single application in the target period is predicted by:
fusing each of n historical traffic sequences with a corresponding processing feature in a first fusion manner, to obtain n first fusion tensors;
extracting a traffic periodical feature based on each of n historical traffic sequences by using the n first fusion tensors; and
predicting a single estimated traffic sequence of the single application in the target period based on the traffic periodical feature and a processing feature of the target period.

5. The computer-implemented method of claim 4, wherein the first fusion manner is embedding.

6. The computer-implemented method of claim 5, comprising:
predicting the estimated traffic sequence of each application in the target period based on the each of n historical traffic sequences of each of the plurality of applications in the n historical periods comprises:
embedding a processing feature of the single application in the target period in the first fusion manner, to obtain a first embedding tensor; and
performing processing based on a multi-head attention mechanism by using an element in the first embedding tensor as an input of a query Q and by using the traffic periodical feature as an input of a key K and a value V, to obtain the single estimated traffic sequence.

7. The computer-implemented method of claim 5, wherein determining a representation vector of each application of a plurality of applications and a pre-estimated central processing unit utilization of each application based on a configured computing resource share at a previous moment/time period based on an estimated traffic sequence of each application in the target period, comprises:
correspondingly concatenating each estimated traffic sequence and a processing feature of a corresponding application based on a time dimension, to obtain each concatenation tensor; and
determining the representation vector of each application and the pre-estimated central processing unit utilization of each application based on the configured computing resource share at the previous moment/time period based on each concatenation tensor.

8. The computer-implemented method of claim 7, wherein a representation vector of the single application is determined by:
adding a perturbation that satisfies a standard Gaussian distribution to a concatenation tensor corresponding to the single application, to obtain a corresponding perturbation tensor.

9. The computer-implemented method of claim 8, comprising:
processing each element of the corresponding perturbation tensor in the time dimension by using a second coding network of a self-attention mechanism, and obtaining a second coding tensor of the corresponding perturbation tensor by concatenating obtained second coding results.

10. The computer-implemented method of claim 9, comprising:
decoding the second code tensor, to obtain the representation vector of the single application.

11. The computer-implemented method of claim 9, wherein a pre-estimated central processing unit utilization of the single application based on the configured computing resource share at the previous moment/time period is determined by:
processing each element of a concatenation tensor corresponding to the single application in the time dimension by using a first coding network of a self-attention mechanism, to obtain each first coding result;
determining, by using a third coding network of a cross-attention mechanism, a corresponding reward as a reference tensor by using each element of the concatenation tensor as a key K, by using each first coding result as a value V, and by using an element corresponding to the first moment/time period in the concatenation tensor as an input of a query Q; and
processing, by using a decoding network and to obtain the pre-estimated central processing unit utilization of the single application, the representation vector of each application, the reference tensor, and a corresponding element used as the input of the query Q in the concatenation tensor.

12. The computer-implemented method of claim 1, wherein a computing resource is represented by using a virtual machine instance, and the current computing resource configuration policy comprises a quantity of virtual machine instances allocated to each application.

13. The computer-implemented method of claim 1, wherein an input of the decision network comprises a computing resource configuration share based on a previous decision and a processing feature of the target period, wherein the output result of the decision network is a computing resource adjustment share of each application, and wherein the current computing resource configuration policy is determined by adjusting a previous computing resource configuration policy based on the computing resource adjustment share of each application.

14. The computer-implemented method of claim 13, wherein the long-term reward is negatively correlated with both the gap and a computing resource adjustment share conversion cost.

15. The computer-implemented method of claim 1, wherein adjusting the current resource configuration policy with an objective of maximizing the long-term reward, comprises:
adjusting, as an adjusted representation vector, the representation vector of each application with the objective of maximizing the long-term reward.

16. The computer-implemented method of claim 15, comprising:
determining, based on the adjusted representation vector the pre-estimated central processing unit utilization of each application.

17. The computer-implemented method of claim 16, comprising:
making, by the decision network, a decision based on the adjusted representation vector and the pre-estimated central processing unit utilization of each application, to determine the current computing resource configuration policy.

18. The computer-implemented method of claim 1, comprising:
when the long-term reward meets a predetermined condition, performing, based on the current computing resource configuration policy, resource configuration for each application at the first moment/time period in the target period.

19. A non-transitory, computer-readable medium storing one or more instructions executable by a computer system to perform one or more operations for computing resource configuration, comprising:
determining, based on a configured computing resource share at a previous moment/time period based on an estimated traffic sequence of each application in a target period a representation vector of each application of a plurality of applications and a pre-estimated central processing unit utilization of each application, wherein the estimated traffic sequence of each application in the target period is predicted in advance based on n historical traffic sequences of each of the plurality of applications in n historical periods;
inputting the pre-estimated central processing unit utilization of each application, the representation vector of each application, and the estimated traffic sequence of each application in the target period into a decision network;
determining a current computing resource configuration policy of a first moment/time period based on an output result of the decision network; and
evaluating, by using a predetermined policy evaluation network, a long-term reward brought by the current computing resource configuration policy, to adjust the output result of the decision network with an objective of maximizing the long-term reward, so as to adjust a current resource configuration policy, wherein the long-term reward is determined based on a gap between central processing unit utilization under the current computing resource configuration policy and a predetermined target central processing unit utilization.

20. A computer-implemented system for computing resource configuration, comprising:
one or more computers; and
one or more computer memory devices interoperably coupled with the one or more computers and having tangible, non-transitory, machine-readable media storing one or more instructions that, when executed by the one or more computers, perform one or more operations, comprising:
determining, based on a configured computing resource share at a previous moment/time period based on an estimated traffic sequence of each application in a target period a representation vector of each application of a plurality of applications and a pre-estimated central processing unit utilization of each application, wherein the estimated traffic sequence of each application in the target period is predicted in advance based on n historical traffic sequences of each of the plurality of applications in n historical periods;
inputting the pre-estimated central processing unit utilization of each application, the representation vector of each application, and the estimated traffic sequence of each application in the target period into a decision network;
determining a current computing resource configuration policy of a first moment/time period based on an output result of the decision network; and
evaluating, by using a predetermined policy evaluation network, a long-term reward brought by the current computing resource configuration policy, to adjust the output result of the decision network with an objective of maximizing the long-term reward, so as to adjust a current resource configuration policy, wherein the long-term reward is determined based on a gap between central processing unit utilization under the current computing resource configuration policy and a predetermined target central processing unit utilization.
